(19) United States
(12) Patent Application Publication
(10) Pub. No.: US 2016/0283591 A1
(43) Pub. Date: Sep. 29, 2016

(54) METHOD FOR PROVIDING SOCIAL ACTIVITY INTEGRATION SERVICE

(71) Applicant: Jong Jin EUN, Anyang-si (KR)

(72) Inventor: Jong Jin EUN, Anyang-si (KR)

(21) Appl. No.: 14/852,602

(22) Filed: Sep. 13, 2015

(30) Foreign Application Priority Data
Mar. 27, 2015 (KR) 10-2015-0043530

(51) Int. Cl. G06F 17/30

(52) U.S. Cl. CPC G06F 17/30864; G06F 17/3089

(57) ABSTRACT

A method for providing a social activity integration service run on a social activity integration service providing server comprises designating and inserting a unique key and an embeddable commenting program, into a web content of a website, inserting the unique key into an app content corresponding to the web content where the unique key is designated and to be uploaded to an appsite or an application, crawling the appsite and the application using an app crawler to extract an app content having the same key as the unique key of the website, inserting comment data of the extracted app content to be integrated with comment data of the web content of the website, and integrating the comment data of the app content and the comment data of the web content into the comment data of the web content and displaying the integrated data.

### CROSS-REFERENCE TO RELATED APPLICATIONS

This patent application claims priority under 35 U.S.C. §119 to Korean Patent Application No. 10-2015-0043530, filed on Mar. 27, 2015, in the Korean Intellectual Property Office, the disclosure of which is incorporated by reference herein in its entirety.

### TECHNICAL FIELD

The present disclosure concerns methods for providing social activity integration services.

### DISCUSSION OF RELATED ART

As smartphones, smartpads, or other mobile devices spread, more and more users prefer to use apppages (also called appsites) instead of webpages or websites, resulting in reduced access to webpages through personal computers. Accordingly, there is a need for a method for prompting the use of the conventional websites, e.g., by integrating app contents from appsites with web contents from websites corresponding to the appsites.

### SUMMARY

According to an embodiment of the present disclosure, a method for providing a social activity integration service run on a social activity integration service providing server comprises designating and inserting a unique key and an embeddable commenting program into a web content of a website, inserting the unique key into an app content corresponding to the web content where the unique key is designated and to be uploaded to an appsite or an application, crawling the appsite and the application using an app crawler to extract an app content having the same key as the unique key of the website, inserting comment data of the extracted app content to be integrated with comment data of the web content of the website, and integrating the comment data of the app content and the comment data of the web content into the comment data of the web content and displaying the integrated data.

The commenting program may be a commenting program embeddable regardless of a language of the website.

Crawling the appsite and the application using the app crawler to extract the app content having the same key as the unique key of the website may include parsing the app content to determine whether the app content has the same unique key as the unique key of the web content, when the app content has the same unique key as the unique key of the web content, extracting an identification (ID) of the app content, transmitting a comment extraction query together with the extracted ID of the app content to a server of a website where the app content is uploaded, and collecting comment data uploaded, to the app content in response to the comment extraction query.

The method may further comprise, after integrating the comment data of the app content and the comment data of the web content into the comment data of the web content and displaying the integrated data, mapping the integrated comment data with the web content and the app content and storing the integrated data in a database.

The method may further comprise periodically extracting the comment data of the app content corresponding to the web content using the app crawler and performing comparison and analysis on the extracted comment data and the stored comment data, and when the extracted comment data is not identical to the stored comment data, adding the extracted comment data to create a database. When the number of data items of the extracted comment data is not identical to the number of data items of the stored comment data, and the extracted comment data is edited or deleted, the database may be updated, and the comment data of the webpage is synced with the updated database.

The appsite or the application may include a social network service (SNS) appsite or an SNS application.

When comment data of the app content is extracted, personal information and location information on a user that uploads the comment data of the app content may be extracted.

Inserting the comment data of the extracted app content to be integrated with the comment data of the web content of the website may include sorting the comment data of the web content and the comment data of the app content based on at least one criterion and inserting the sorted comment data to be integrated.

According to an embodiment of the present disclosure, a method for providing an application operating a mobile terminal and a stationary terminal while interacting with a social activity integration service, providing server executes a method for providing a social activity integration service. The method may comprise designating and inserting a unique key and an embeddable commenting program into a web content of a website, inserting the unique key into an app content corresponding to the web content where the unique key is designated and to be uploaded to an appsite or an application, crawling the appsite and the application using an app crawler to extract an app content having the same key as the unique key of the website, inserting comment data of the extracted app content to be integrated with comment data of the web content of the website, and integrating the comment data of the app content and the comment data of the web content into the comment data of the web content and displaying the integrated data.

### BRIEF DESCRIPTION OF THE DRAWINGS

A more complete appreciation of the present disclosure and many of the attendant aspects thereof will be readily obtained as the same becomes better understood by reference to the following detailed description when considered in connection with the accompanying drawings, wherein:

FIG. 1 is a view illustrating a system for providing an integrated social activity integrated service according to an embodiment of the present disclosure;

FIG. 2 is a view illustrating a configuration of a social activity integration service providing server as shown in FIG. 1;

FIGS. 3a, 3b, 3c, 3d, 3e, and 3f are views illustrating an example of an implementation of a social activity integration service as shown in FIG. 1;

FIGS. 4a, 4b and 4c are views illustrating another example of an implementation of a social activity integration service as shown in FIG. 1;

FIG. 5 is a view illustrating, a process in which components in a social activity integration service providing system as shown in FIG. 1 communicate data therebetween according to an embodiment of the present disclosure; and

FIG. 6 is a flowchart illustrating a social activity integration service providing method according to an embodiment of the present disclosure.

### DETAILED DESCRIPTION OF EMBODIMENTS

Hereinafter, exemplary embodiments of the inventive concept will be described in detail with reference to the accompanying drawings. The inventive concept, however, may be modified in various different ways, and should not be construed as limited to the embodiments set forth herein. As used herein, the singular forms “a,” “an,” and “the” are intended to include the plural forms as well, unless the context clearly indicates otherwise. It will be understood that when an element or layer is referred to as being “on,” “connected to,” “coupled to,” or “adjacent to” another element or layer, it can be directly on, connected, coupled, or adjacent to the other element or layer, or intervening elements or layers may be present. Like reference denotations may be used to refer to like or similar elements throughout the specification and the drawings.

As used herein, the term “app” may be an abbreviation of the term “application.”

As used herein, the term “apppage” may denote a webpage that may be optimized for a mobile device (e.g., a smartphone or smartpad) and may be primarily subjected to use or display on a mobile device.

As used herein, the terms “webpage” and “website” may be interchangeably used, and the terms “apppage” and “appsite” may be interchangeably used.

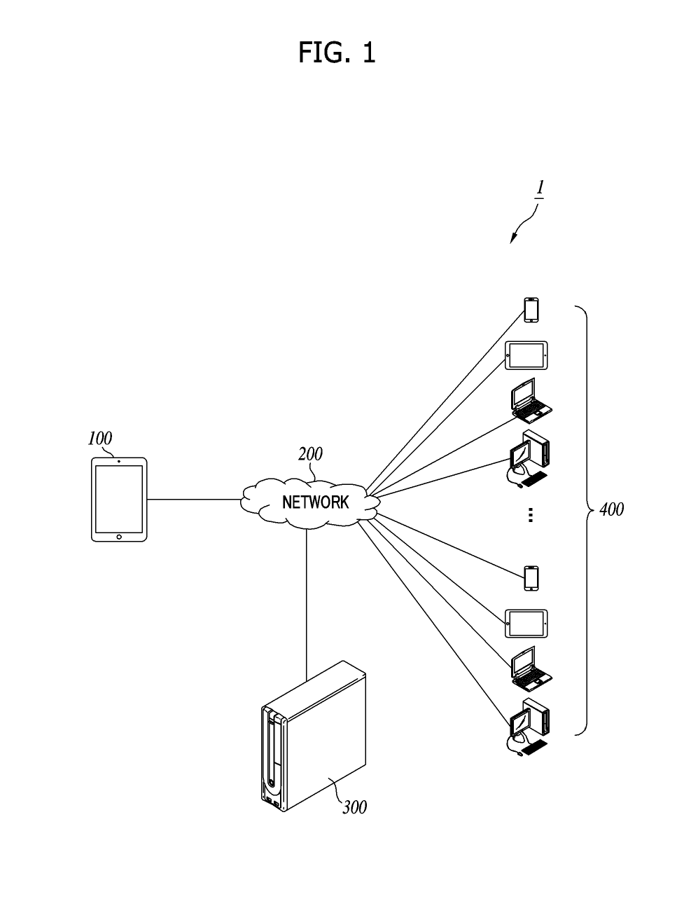

FIG. 1 is a view illustrating a system for providing an integrated social activity integrated service according to an embodiment of the present disclosure. Referring to FIG. 1, the system 1 for providing a social activity integration service may include a content providing server 100, a social activity integration service providing server 300, and at least one user terminal 400. However, the social activity integration service providing system 1 is merely an example, and embodiments of the present disclosure are not limited thereto.

The components shown in FIG. 1 are connected with one another via a network 200. For example, as shown in FIG. 1, the content providing server 100 may be connected with the social activity integration service providing server 300 via the network 200. The social activity integration service providing server 300 may be connected with at least one user terminal 400 via the network 200. The content providing server 100 may be connected with at least user terminal 400 via the network 200.

Here, the term “network 200” may mean a connection structure that enables information exchange between nodes, such as terminals or servers. Examples of the network 200 may include, but is not limited to, the Internet, a local area network (LAN), a wireless local area network (WLAN), a wide area network (WLAN), a personal area network (PAN), a 3^{rd} generation (3G) or 4^{th} generation (4G) network, a long term evolution (LTE) network, or a wireless fidelity (Wi-Fi) network. The content providing server 100, the social activity integration service providing server 300, and the at least one user terminal 400 are not limited to those shown in FIG. 1.

The content providing server 100 may be a server that uploads contents on a website. The content providing server 100 may be a server that provides a homepage of a business entity, a press, an individual, or a small or mid-sized company, or any other types of servers that may provide contents for uploading users' comments. The content providing server 100 may be implemented as a terminal that may access a remote server or terminal through the network 200. The content providing server 100 may be implemented as a computer that may access a remote server or terminal via the network 200. The computer may include, e.g., a laptop computer or a desktop computer.

The social activity integration service providing server 300 may be a server that integrates comments on a website with comments uploaded onto an appsite, e.g., a social network appsite and application. For example, more comments may be posted on an appsite and application including a social network service than on a website due to more vigorous use of smartphone and social network accounts although the appsite and application and the website provide the same contents. Accordingly, the social activity integration service providing server 300 may integrate the comments posted on the website and the appsite and apply the integrated comments to the website to activate the website. Further, the social activity integration service providing 300 may integrate social activities on the appsite, making it possible to exactly grasp users' reaction to the contents.

To that end, the social activity integration service providing server 300 may provide a commenting program that may be embedded regardless of the language used to the content providing server 100, extract comments in the apppage using an app crawler, and integrate the comments extracted from the apppage with the webpage. The social activity integration service providing server 300 may be implemented as a terminal that may access a remote server or terminal through the network 200. The social activity integration service providing server 300 may be implemented as a computer that may access a remote server or terminal through the network 200. For example, the computer may include a laptop computer or a desktop computer.

The user terminal 400 may be a terminal that may upload comments for the contents uploaded to the website or appsite from the content providing server 100. The user terminal 400 may be a terminal that may edit or delete comments. The user terminal 400 may be implemented as a terminal that may access a server or terminal via the network 200.

The user terminal 400 may be implemented as a computer that may access a remote server or terminal via the network 200. The computer may include; e.g., a laptop computer or a desktop computer. The user terminal 400 may be implemented as a terminal that may access a remote server or terminal via the network 200.

The messaging unit 400 may be a wireless communication device that ensures portability and mobility and may include any type of handheld wireless communication devices, e.g., a personal communication system (PCS), a global system for mobile communications (GSM) terminal, a personal digital cellular (PDC) terminal, a personal handyphone system (PHS), a personal digital assistant (PDA), an international mobile telecommunication (IMT)-2000 terminal, a code division multiple access (CDMA)-2000 terminal, a wideband CDMA (WCDMA) terminal, a wireless broadband (Wibro) terminal, a smartphone, a smartpad, or a tablet personal computer (PC).

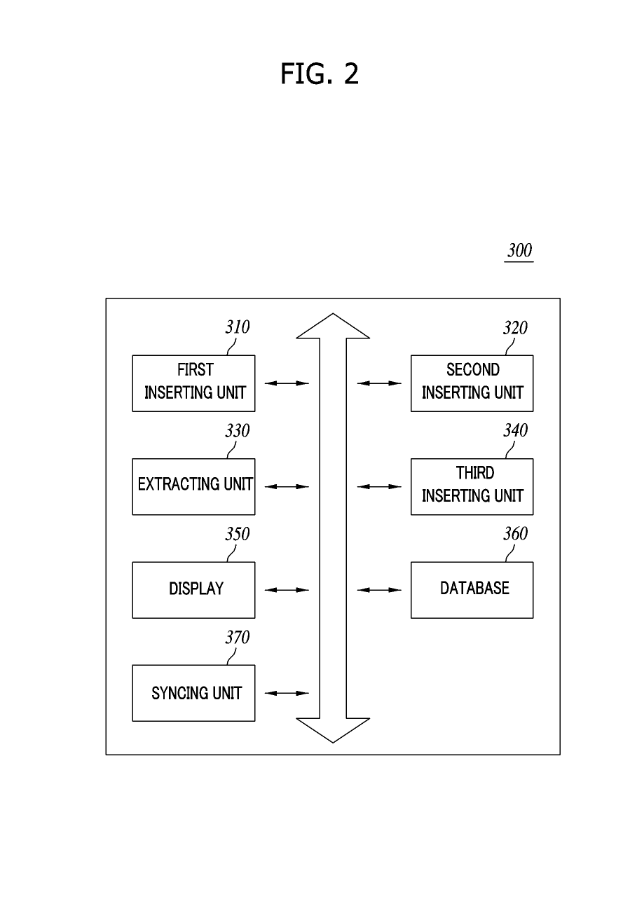

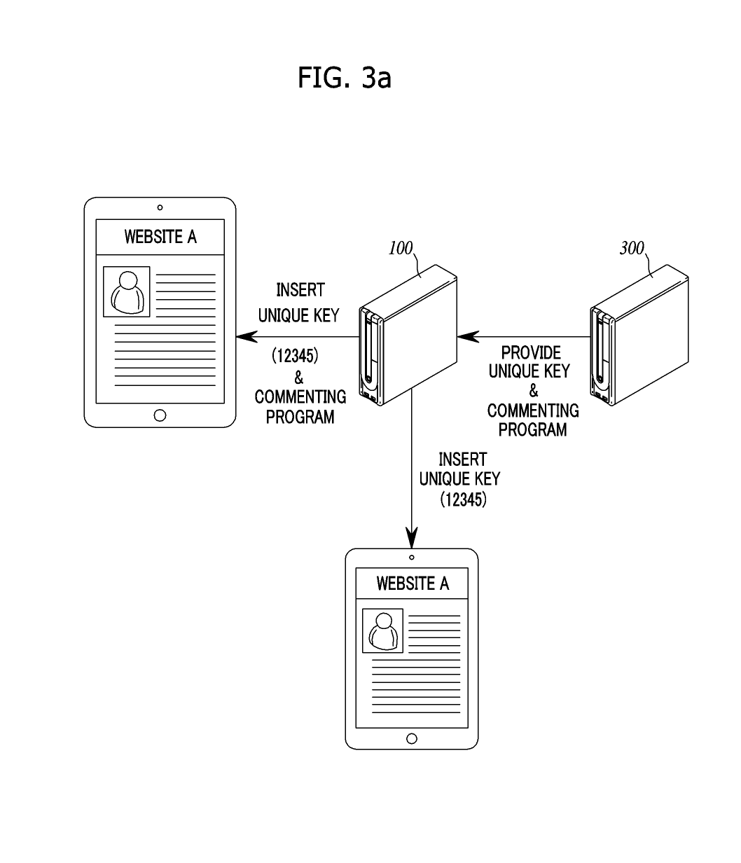

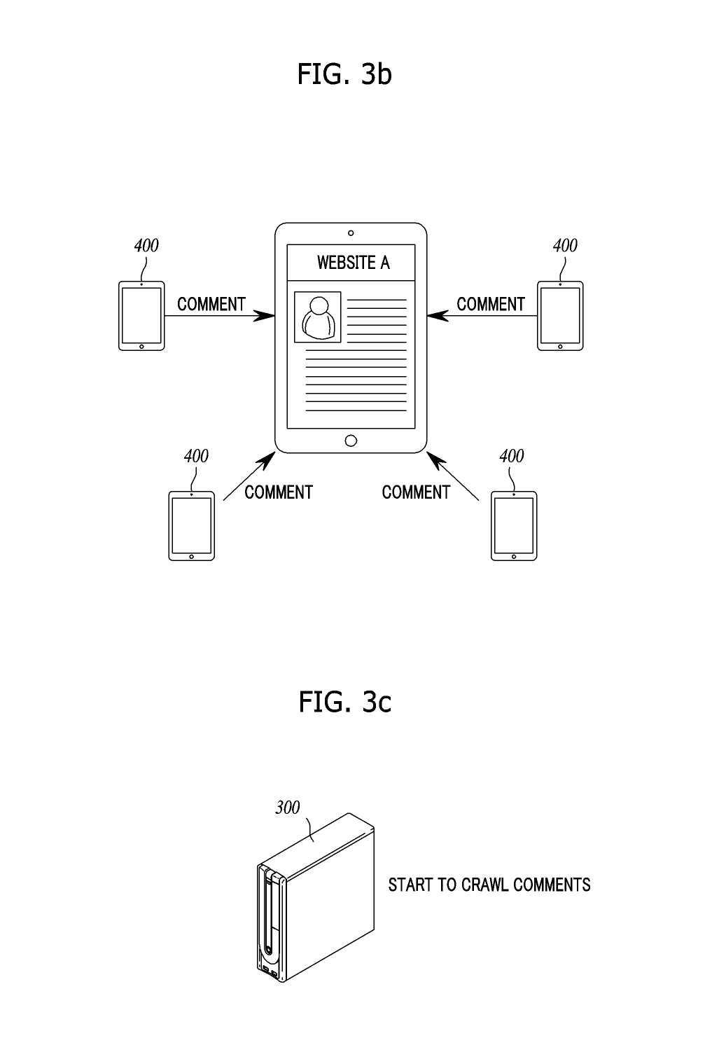

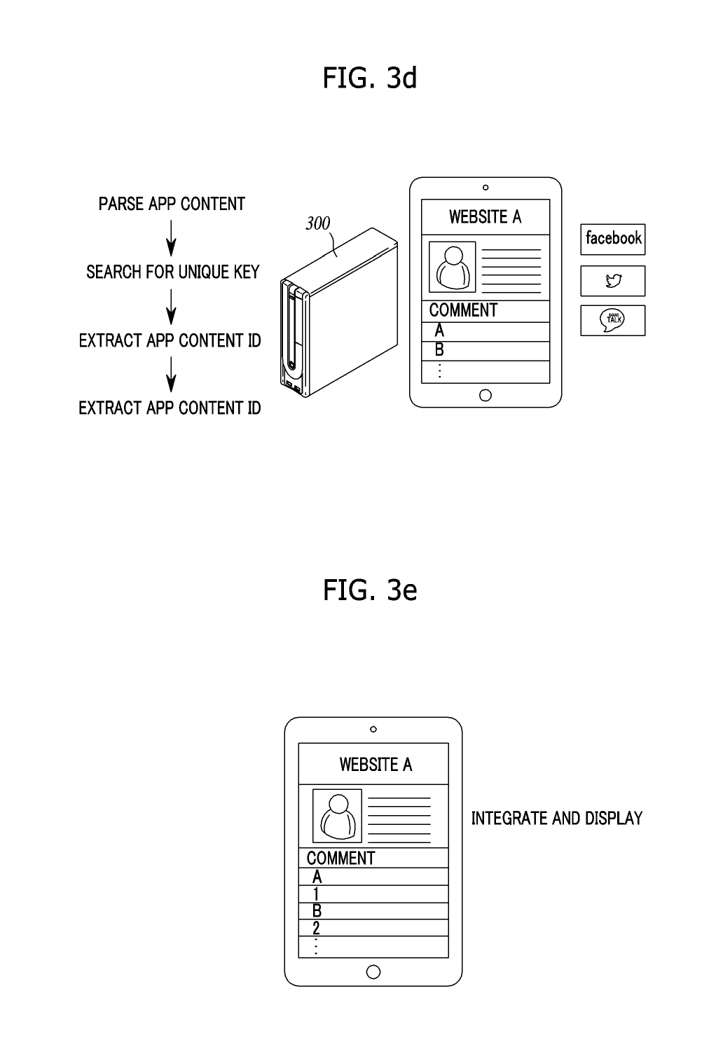

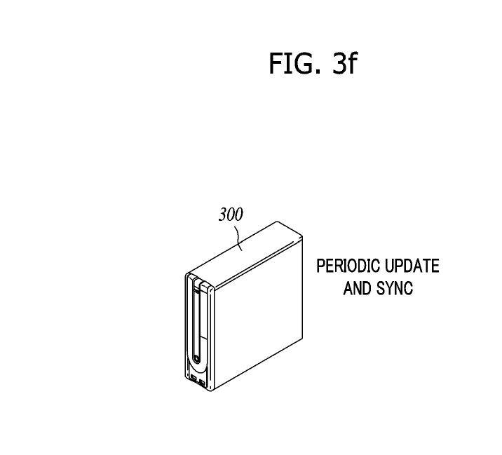

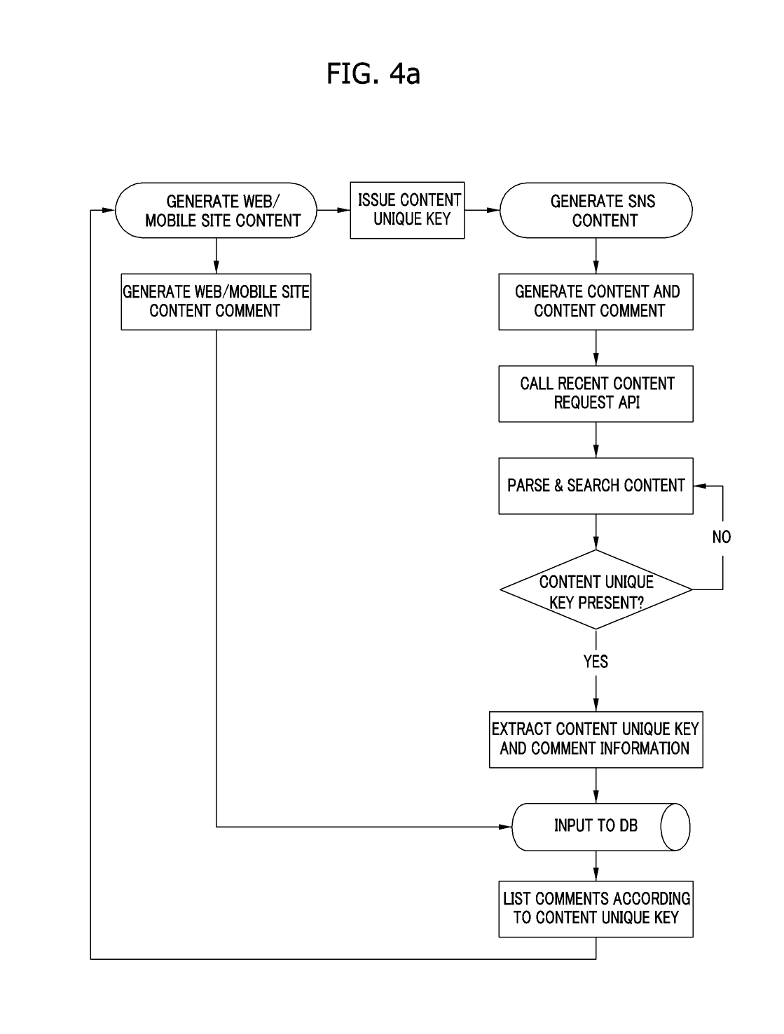

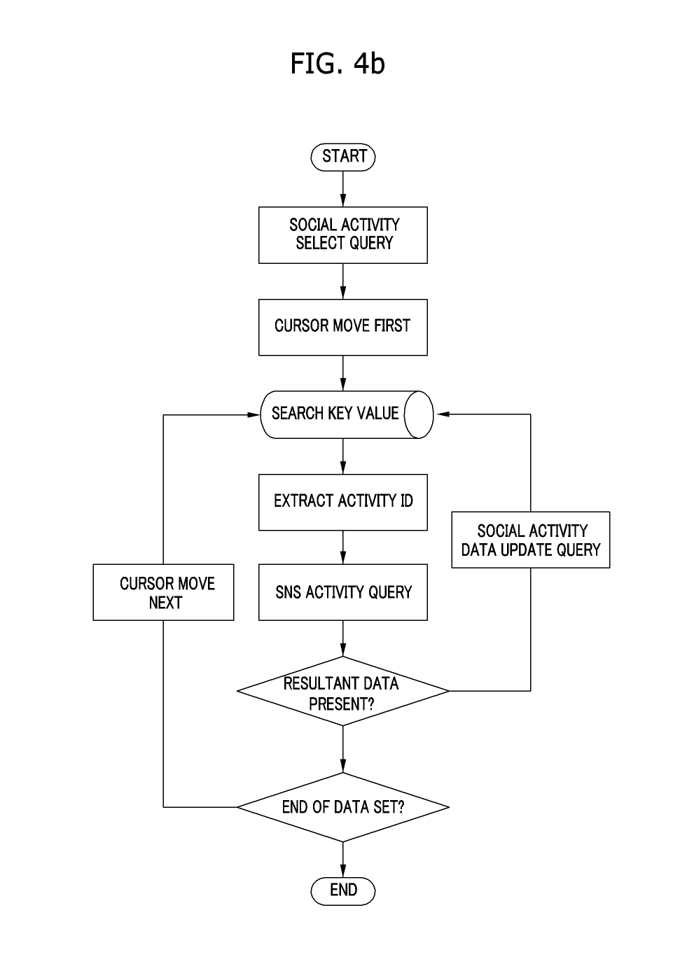

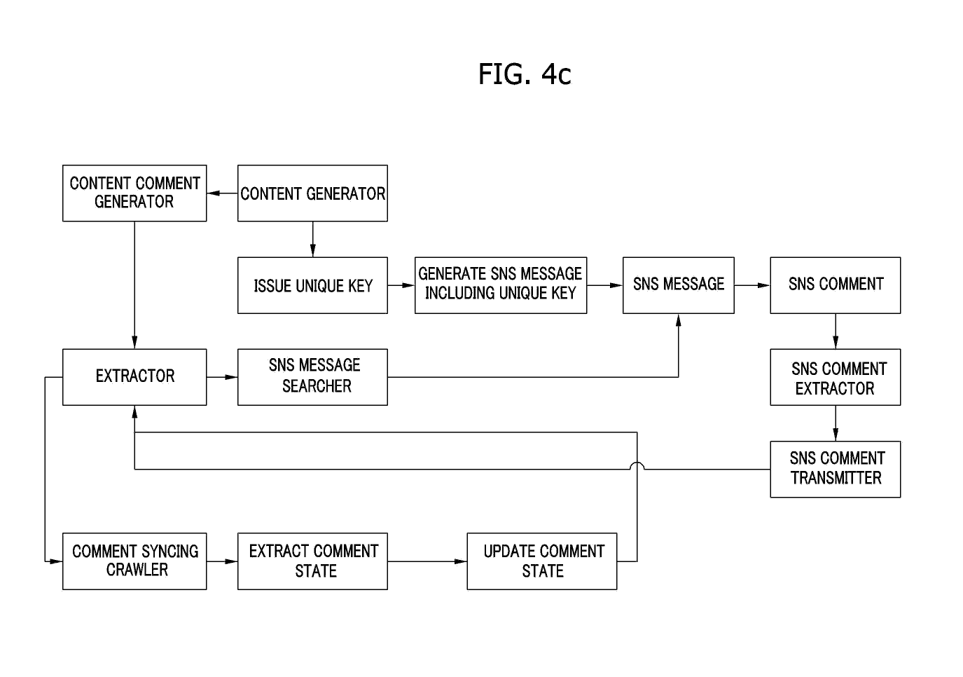

FIG. 2 is a view illustrating a configuration of a social activity integration service providing server as shown in FIG. 1 FIGS. 3a, 3b, 3c, 3d, 3e, and 3f are views illustrating an example of an implementation of a social activity integration service as shown in FIG. 1. FIGS. 4a, 4b, and 4c are views illustrating another example of an implementation of a social activity integration service as shown in FIG. 1.

Referring to FIG. 2, the social activity integration service providing server 300 may include a first inserting unit 310, a second inserting unit 320, an extracting unit 330, a third inserting unit 340, display 350, a database 360, and a syncing unit 370.

When the social activity integration service providing server 300 or another server (not shown) interacting with the social activity integration service providing server 300 transmits, e.g., a social activity integration service application, program, or webpage to the terminal through the network 200, the terminal may install or open the application, program, or webpage for the service. The application, program, or webpage may also be driven on the terminal using a script run on a web browser.

The web browser may be a program that enables use of a worldwideweb (WWW) service and may mean a program that receives a hypertext written in hypertext mark-up language (HTML). The web browser may include, e.g., Netscape, Explorer, or Chrome. The application may mean an application program operating on the terminal and may include, e.g., an application (also shortly referred to as an “app”) run on a mobile terminal (e.g., a smartphone). The app may be downloaded and installed from a mobile application market that is a virtual market where mobile contents may be purchased or sold.

The content providing server 100, the social activity integration service providing server 300, and the at least one user terminal 400 may be connected with one another via the network 200 in a communicable manner. Generating a network 200 connection may mean that the social activity integration service providing server 300 generates a communication object in a communication contact in order to communicate with a terminal connected thereto via the network 200. The social activity integration service providing server 300 may exchange data through the communication object.

The first inserting unit 310 may designate and insert an embeddable commenting program and a unique key into a web content of a website. For example, the first inserting unit 310 may provide the unique key for identifying the web content to the social activity integration service providing server 300. The unique key may be used to distinguish a web content of a webpage from an app content of an apppage. Since the embeddable commenting program needs to integrate and insert the comment of the apppage to the webpage, the first inserting unit 310 transmits the commenting program to the content providing server 100 so that the content providing server 100, when uploading the web content, may insert and upload the program together. Here, the commenting program may be an embeddable commenting program regardless of the language of the website. For example, the commenting program may be a commenting program that may be embedded even when the website uses a different language.

The second inserting unit 320 may insert a unique key to the app content that corresponds to the web content where the unique key is designated and that is to be uploaded to the appsite or application. For example, the second inserting unit 320 may transmit the unique key to the content providing server 100 so that the same unique key inserted by the first inserting unit 310 may also be inserted into the app content. Accordingly, the content providing server 100 may insert the transmitted unique key and upload the app content. Thereafter, the unique key may be used to discover the same app content as the web content.

The extracting unit 330 may extract the app content having the same key as the unique key of the website by crawling the appsite and application using an app crawler. To that end, the extracting unit 330 may parse the app content to determine whether the app content is the app content having the same unique key as the unique key of the web content. In other words, contents may be collected using the app crawler, the collected contents may be parsed, the unique key may be searched from among the data output by parsing the collected contents, and it may be determined whether the searched unique key is the same as the unique key of the web content intended to integrate the current comments.

When it is determined that the app content has the same unique key as the web content, the extracting unit 330 may extract the identification (ID) of the app content. The extracting unit 330 may send a comment extraction query, together with the extracted ID of the app content, to the server of the website where the app content is uploaded. Then, the extracting unit 330 may collect comment data uploaded to the app content in response to the comment extraction query. For the purpose of description, web content B of company A is disclosed on the webpage, and the unique key of web content B is 12345, for example. For the purpose of description, the unique key of app content B corresponding to web content B is 12345, and the ID of app content B is XXX.123, for example. For example, the extracting unit 330 periodically or in real-time extracts app contents A, B, C, D, E, and F using an app crawler, for the purpose of description. Since the app content intended to be discovered by the extracting unit 330 is app content B corresponding to web content B, the extracting unit 330 parses app contents A, B, C, D, E, and F to extract the unique key and identifies whether there is an app content matching the unique key, 12345, of web content B.

The extracting unit 330 might not directly compare web content B with app content B because the layout or number of images or content in the appsite, unlike the website, may be shown in brief or in a summarized manner, and thus, one-to-one comparison in text, images, and videos between the appsite and website may result in different results of determination on the same content. Accordingly, the extracting unit 330 searches for the webpage using the app crawler and parses the searched webpage to identify the unique key. Then, the extracting unit 330, upon identifying that web content B is the same as app content B, may extract the ID (e.g., XXX.123) of app content B, transmit the ID and a query to send a request for comments to a server, e.g., Facebook, Kakaotalk, or Twitter, and receive a feedback having a comment of app content B having the ID. Accordingly, the extracting unit 330 may extract the comment of a plurality of B corresponding to webpage B using the unique key and the ID.

In this case, when extracting the comment data of the app content, the extracting unit 330 may also extract the personal information and location information on the user that has uploaded the comment data of the app content. For example, since the user's personal information and location information may be used when the comment data is used for advertising or marketing or when it is required to grasp a distribution of users per area, age, or sex, the personal information and location, once made public, may be extracted as well.

The third inserting unit 340 may insert the extracted comment data of app content to be integrated with the comment data of the web content in the website. Here, the appsite or application may include a social network service (SNS) appsite or an SNS application. When inserting the extracted comment data of the app content to be integrated with the comment data of the web content in the website, the third inserting unit 340 may sort the comment data of the web content and the comment data of the app content based on at least one criterion and may insert the sorted comment data to be integrated. For example, when the comment data is sorted based on time, under an exemplary circumstance where the comments of the website are sorted in an alphabetic order (e.g., A, B, C . . . ), and the comments of the appsite are sorted in a numeric order (e.g., 1, 2, 3, . . . ), and 1, 2, and 3, respectively, are temporally positioned between A and B, between B and C, and after C, the comments may be sorted in order of time, such as A-1-B-2C-3.

The display 350 may integrate the comment data of the app content and the comment data of the web content into the comment data of the web content and display the integrated data.

After the display 350 may integrate the comment data of the app content and the comment data of the web content into the comment data of the web content and display the integrated data, the database 360 may map the integrated comment data to the web content and the app content and store the mapped data, creating a database.

The syncing unit 370 may periodically extract the comment data of the app content corresponding to the web content using the app crawler and may compare and analyze the extracted comment data and the stored comment data. When the extracted comment data is not the same as the stored comment data, the syncing unit 370 may add the extracted comment data, creating a database. When the number of data items of the extracted comment data is not the same as the number of data items of stored comment data items, and the extracted comment data is edited or deleted, the database may be updated, and the comment data of the webpage may be synced with the updated database.

Now described in detail is a social activity integration service by a social activity integration service providing server having the above-described configuration, with reference to FIGS. 3 and 4.

Referring to FIG. 3, the social activity integration service providing server 300 provides a unique key and a commenting program, and the content providing server 100 inserts the unique key into the web content of the website and the app content of the appsite. The content providing server 100 inserts the commenting program into the website and uploads the same. When at least one user terminal uploads a comment to the app content of the appsite, the social activity integration service providing server 300 starts crawling to integrate comments. Then, the social activity integration service providing server 300 parses the app content, searches for the unique key, extracts the ID of the app content, and sends a comment request query to the server of the website including the app content. Then, the social activity integration service providing server 300, when receiving the comment, integrates the comment with the web content of the website and displays the integrated result and periodically performs crawling. When the comment of the app content in the appsite is edited or deleted, the social activity integration service providing server 300 performs update so that the website is synced with the same.

Referring to FIG. 4, when the content providing server 100 creates the web content of the website and the app content of the appsite, the social activity integration service providing server 300 issues a unique key to be inserted. Then, the social activity integration service providing server 300 calls a content request API, parses the contents, identifies whether there is a unique key, and when there is a unique key, extracts the unique key and comment information to create a database, and then lists and integrates comments according to the content unique key. When extracting the comment, the social activity integration service providing server 300 makes a request for a comment extraction query, searches for a unique key value, and after the unique key value is searched, extracts the content ID to inquire whether there is a comment. When there is a comment, the social activity integration service providing server 300 continues to repeat the crawling, unique key search, ID extraction, comment extraction, and update until the data set is complete.

Other steps or operations in the social activity integration service providing method described above in connection with FIGS. 2 and 4 may be substantially the same or easily inferred from the social activity integration service providing method described above in connection with FIG. 1, and thus, no further detailed description thereof is given.

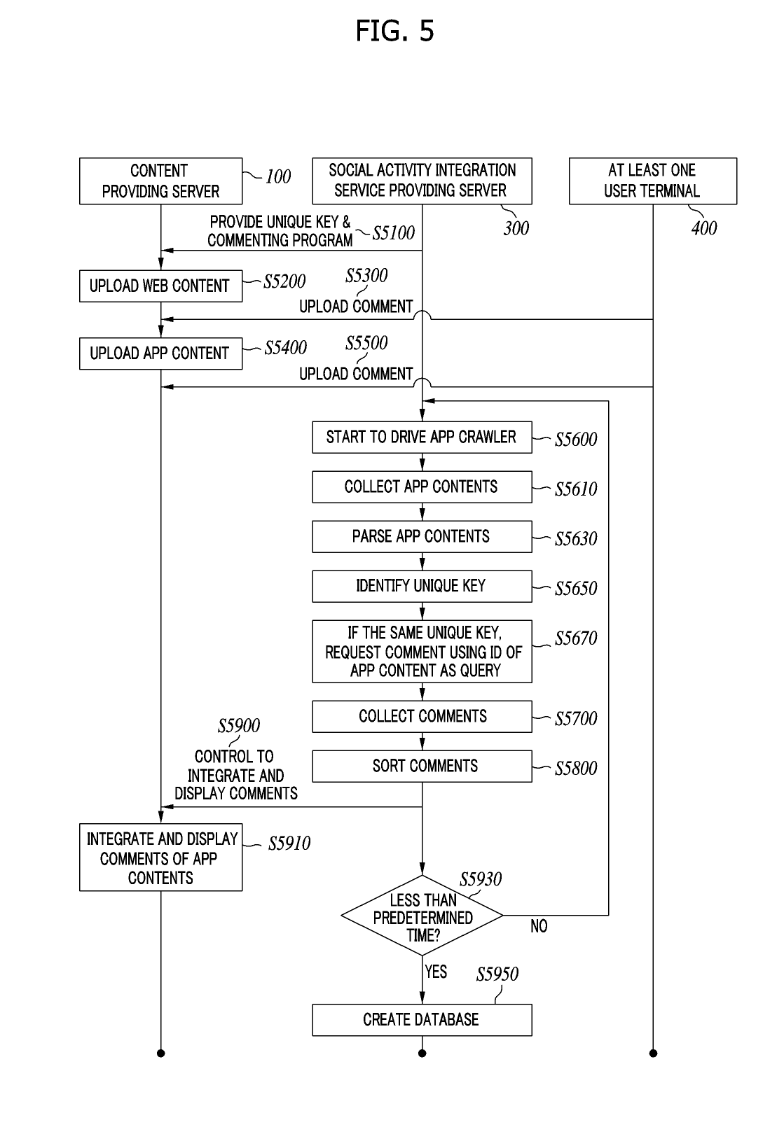

FIG. 5 is a view illustrating a process in which components in a social activity integration service providing system as shown in FIG. 1 communicate data therebetween according to an embodiment of the present disclosure. Hereinafter, an exemplary process in which signals are communicated according to an embodiment of the present disclosure is described, but embodiments of the present disclosure are not limited thereto. For example, various changes may be made to the process shown in FIG. 5 according to the above-described embodiments.

Referring to FIG. 5, the social activity integration service providing server 300 provides a unique key and a commenting program (S5100), and the social activity integration service providing server 300 uploads a web content (S5200). At least one user terminal 400 may upload a comment (S5300).

The social activity integration service providing server 300 may upload an app content (S5400), and the at least one user terminal 400 may upload a comment (S5500).

The social activity integration service providing server 300 starts to drive an app crawler (S5600), collects the app contents (S5610), parses the collected app contents (S5630), and searches and identifies the unique key (S5650).

The social activity integration service providing server 300, when the unique key of the app content is the same as the unique key of the web content, sends a request for a comment using the ID of the app content as a query (S5670).

Then, the social activity integration service providing server 300 collects the comments (S5700), sort the collected comments (S5800), and controls the content providing server 100 to integrate and display the comments (S5900).

In this case, the content providing server 100 uploads on the e webpage and displays the integrated comments (S5910).

Then, after a predetermined time elapses, the social activity integration service providing server 300 repeats steps S5600 to S5910 to perform update and sync on the database. Unless the predetermined time elapses, the social activity integration service providing server 300 creates the current state into a database (S5950).

The order of the above steps S5100 to S5950 is merely an example, and embodiments of the present disclosure are not limited thereto. For example, the above steps S5100 to S5950 may be performed in different orders, and some of the steps may be simultaneously performed or omitted.

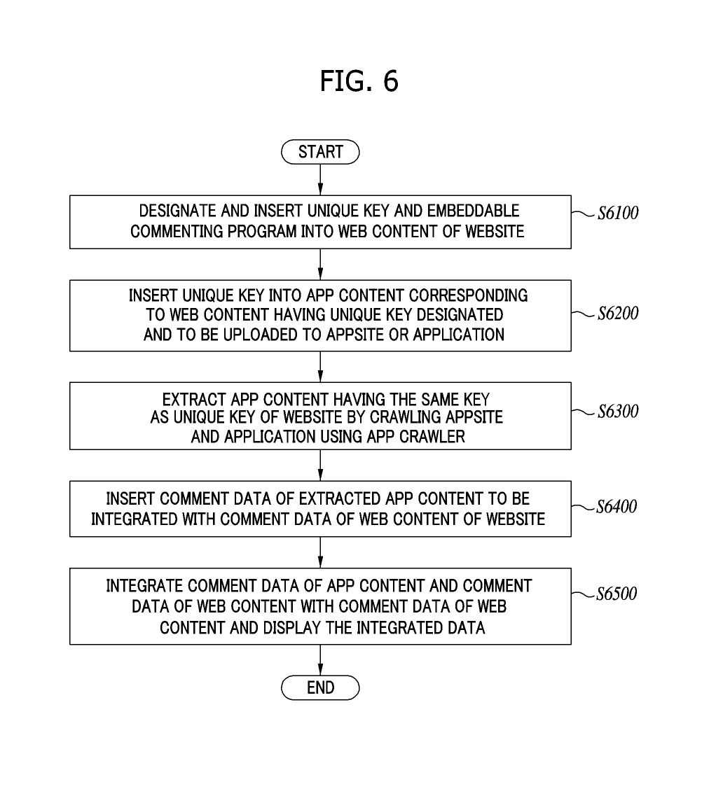

FIG. 6 is a flowchart illustrating a social activity integration service providing method according to an embodiment of the present disclosure. Referring to FIG. 6, the social activity integration service providing server designates and inserts a unique key and an embeddable commenting program into a web content of a website (S6100).

Then, the social activity integration service providing server inserts the unique key into an app content that corresponds to the web content with the unique key designated and that is to be uploaded to an appsite or application (S6200).

The social activity integration service providing server crawls the appsite and the application using an app crawler to extract an app content having the same key as the unique key of the website (S6300).

The social activity integration service providing server inserts the comment data of the extracted app content to be integrated with the comment data of the web content (S6400).

The social activity integration service providing server integrates the comment data of the app content and the comment data of the web content with the comment data of the web content and displays the integrated data (S6500).

The order in which the above steps S6100 to S6500 are performed is merely an example, and embodiments of the present disclosure are not limited thereto. For example, the steps S6100 to S6500 may be performed in different orders, and some of the steps may be simultaneously performed or omitted.

Other steps or operations in the social activity integration service providing method described above in connection with FIG. 6 may be substantially the same or easily inferred from the social activity integration service providing method described above in connection with FIGS. 1 to 5, and thus, no further detailed description thereof is given.

The social activity integration service described above m connection with FIG. 6 may be implemented in the form of a recording medium including commands executed by a computer, such as a program module, or an application executed by a computer. The computer-readable medium may be an available medium that may be accessed by a computer and may include a volatile or non-volatile medium, a separated or non-separated medium. The computer-readable medium may include a computer storage medium or a communication medium. The computer-readable medium may include a volatile, non-volatile, separated, or non-separated medium implemented as a method or technique for storing information such as a computer-readable command, data structure, program module, or other data. The communication medium may include an information transmitting medium that may transfer any types of information including a computer-readable command, data structure, program module, carrier, or other modulated data signals or other data, or other transmission mechanism.

The above-described social activity integration service providing method may be run by an application installed on a terminal (which may include a program included in the platform or operating system mounted on the terminal) or may be run by an application (e.g., a program) installed by the user on a master terminal through an application providing server, such as an application store server, an application or service-related web server, in that sense, the above-described social activity integration service providing method may be implemented as an application (e.g., a program) installed by the user or installed on the terminal as default and may be recorded in a recording medium that may be read by a computer, e.g., a terminal.

According to embodiments of the present disclosure, an embeddable commenting program and a unique key may be inserted into a webpage that is then uploaded, and a unique key may be inserted into an apppage corresponding to the webpage, which is then uploaded. Comments on the apppage may be extracted using a crawler, and the extracted comments may be inserted into the webpage in such a manner as to be integrated with the webpage. By doing so, webpages that tend to be used less and less as compared with apppages may be flourished back. Further, users' responses or reactions may be displayed, integrated with the webpage, enabling users' responses or reactions to any content to be exactly known. Thus, targeted customers may be extracted from the users' responses or reactions, and marketing advertisement, and statistical analysis based on users' preferences are possible.

While the inventive concept has been shown and described with reference to exemplary embodiments thereof, it will be apparent to those of ordinary skill in the art that various changes in form and detail may be made thereto without departing from the spirit and scope of the inventive concept as defined by the following claims.

What is claimed is:

1. A method for providing a social activity integration service run on a social activity integration service providing server, the method comprising:
designating and inserting a unique key and an embeddable commenting program into a web content of a website;
inserting the unique key into an app content corresponding to the web content where the unique key is designated and to be uploaded to an appsite or an application;
crawling the appsite and the application using an app crawler to extract an app content having the same key as the unique key of the website;
inserting comment data of the extracted app content to be integrated with comment data of the web content of the website; and
integrating the comment data of the app content and the comment data of the web content into the comment data of the web content and displaying the integrated data.

2. The method of claim 1, wherein the commenting program is a commenting program embeddable regardless of a language of the website.

3. The method of claim 1, wherein crawling the appsite and the application using the app crawler to extract the app content having the same key as the unique key of the website includes;
parsing the app content to determine whether the app content has the same unique key as the unique key of the web content;
when the app content has the same unique key as the unique key of the web content, extracting an identification (ID) of the app content;
transmitting a comment extraction query together with the extracted ID of the app content to a server of a website where the app content is uploaded; and
collecting comment data uploaded to the app content in response to the comment extraction query.

4. The method of claim 1, further comprising, after integrating the comment data of the app content and the comment data of the web content into the comment data of the web content and displaying the integrated data, mapping the integrated comment data with the web content and the app content and storing the integrated data in a database.

5. The method of claim 4, further comprising:
periodically extracting the comment data of the app content corresponding to the web content using the app crawler; and
performing comparison and analysis on the extracted comment data and the stored comment data, and when the extracted comment data is not identical to the stored comment data, adding the extracted comment data to create a database, wherein when the number of data items of the extracted comment data is not identical to the number of data items of the stored comment data, and the extracted comment data is edited or deleted, the database is updated, and the comment data of the webpage is synced with the updated database.

6. The method of claim 1, wherein the appsite or the application includes a social network service (SNS) appsite or an SNS application.

7. The method of claim 1, wherein when comment data of the app content is extracted, personal information and location information on a user that uploads the comment data of the app content are extracted.

8. The method of claim 1, wherein inserting the comment data of the extracted app content to be integrated with the comment data of the web content of the website includes:
sorting the comment data of the web content and the comment data of the app content base on at least one criterion; and
inserting the sorted comment data to be integrated.

9. A method for providing an application operating a mobile terminal and a stationary terminal while interacting with a social activity integration service providing server executing a method for providing a social activity integration service, the method comprising:
designating and inserting a unique key and an embeddable commenting program into a web content of a website;
inserting the unique key into an app content corresponding to the web content where the unique key is designated and to be uploaded to an appsite or an application;
crawling the appsite and the application using an app crawler to extract an app content having the same key as the unique key of the website;
inserting comment data of the extracted app content to be integrated with comment data of the web content of the website; and
integrating the comment data of the app content and the comment data of the web content into the comment data of the web content and displaying the integrated data.
